(19) United States
(12) Patent Application Publication
(10) Pub. No.: US 2020/0339129 A1
(43) Pub. Date: Oct. 29, 2020

(54) METHOD AND APPARATUS FOR DETECTING A ROAD CONDITION

(71) Applicant: Robert Bosch GmbH, Stuttgart (DE)

(72) Inventors: Simon Weissenmayer, Flein (DE); Timo Koenig, Unterheinriet (DE); Michael Schumann, Stuttgart (DE)

(21) Appl. No.: 16/757,904

(22) PCT Filed: Oct. 4, 2018
(86) PCT No.: PCT/EP2018/076991

§ 371 Date: Apr. 21, 2020

(30) Foreign Application Priority Data
Nov. 9, 2017 (DE) 10 2017 219 898.2

(51) Int. Cl. B60W 40/06; B60T 8/172; G01S 15/931; G06K 9/00

(52) U.S. Cl. CPC B60W 40/06; B60T 8/172; G01S 2015/937; G06K 9/00791; B60T 2210/13; G01S 15/931

(57) ABSTRACT

A method for detecting a road condition in the area of a vehicle using sensor data from an acoustic sensor system of the vehicle. A detection rate of false positive objects reproduced in the sensor data is analyzed in an analysis step in order to detect a current road condition, a current value of the detection rate being analyzed using at least one expected value assigned to a road condition.

### FIELD

The present invention relates to a method and an apparatus for detecting a road condition in the area of a vehicle using sensor data from an acoustic sensor system of the vehicle.

### BACKGROUND INFORMATION

Environmental influences, such as rain, sleet, hail or snow, can reduce a vehicle's road contact, thereby lengthening a braking distance of the vehicle. In the case of hydroplaning, the vehicle even loses road grip. Special sensors are able to capture such environmental influences.

For example, an optical rain sensor in a windshield of the vehicle can detect precipitation. A precipitation-induced change in the road condition can be inferred from detection of the precipitation.

### SUMMARY

The present invention provides a method for detecting a road condition in the area of a vehicle using sensor data from an acoustic sensor system of the vehicle, a corresponding apparatus, as well as a corresponding computer program.

Advantageous embodiments of the present invention and improvements thereto are described herein.

Specific embodiments of the present invention may make it advantageously possible to infer a road condition without any special additional sensors on the vehicle and using already existing information. Already existing ultrasonic transceiver units of the vehicle are thereby used. In the approach provided here, an already existing sensor signal from the ultrasonic transceiver units is read in and analyzed in order to infer the road condition.

Example embodiments of the present invention makes it possible to detect hydroplaning at an earlier stage and more reliably. Moreover, hydroplaning may be predicted. The driver is able to be warned about hydroplaning at an earlier stage. As a result, the vehicle is able to better respond to predicted and sudden hydroplaning, and accidents caused by hydroplaning may be more effectively prevented. The water level data may be fed back to the weather service, which is thereupon better able to supply the weather model thereof with data, and thus compute a better flood warning, for example. In the case of permanent and sporadic defects, the troubleshooting is facilitated by additional information on the driving environment.

The wetness on the road could also be determined by video or radar. However, using ultrasonic sensors for the analysis may lead to better and more accurate predictions.

In accordance with the present invention, an example method for detecting a road condition in the area of a vehicle using sensor data from an acoustic sensor system of the vehicle is provided which includes a detection rate of false positive objects, which is reproduced in the sensor data, being analyzed in an analysis step in order to detect a current road condition, a current value of the detection rate being analyzed using at least one expected value assigned to a road condition.

In accordance with the present invention, an example apparatus is also provided for detecting a road condition that is adapted for executing, implementing, and/or controlling the detection method in corresponding devices.

Specific embodiments and improvements of the present invention may be considered, inter alia, as being based on the description herein and the figures.

The road condition may be described as a condition of a roadway caused by water in solid or liquid form. The roadway may be damp, wet, muddy or flooded, for example. In the same way, it is self-evident that the roadway may be dry in the absence of water. In comparison to the dry roadway, an ambient noise (in the specific case, rolling noise of the tires) of a vehicle changes appreciably when the vehicle is driven over a damp, wet, or even flooded area. Above a certain quantity of water on the roadway, the water is also splashed up by the tires and hits the vehicle where additional noise is generated. If there is even more water on the roadway, the displacement due to the tires causes plumes of water to form that may likewise partially hit the vehicle. Superimposed on these noises is a wind noise caused by the airflow produced by the subject vehicle. The wind noise is dependent on a velocity of the air relative to the vehicle.

A sensor system may be an ultrasonic sensor system. Sensor data may include acoustic information from a sensor or from a plurality of sensors of the sensor system. The sensor data may already be preprocessed. The sensor data of the ultrasonic sensor system may indicate distances to detected objects and the probability of detection, respectively quality thereof. Objects, which are associated with a low probability of detection, may also be referred to as false positive objects. Water droplets, thus splashed-up water and/or plumes of water, may be recognized as a multiplicity of objects having a low probability of detection. The probability of detection is thereby dependent, inter alia, on the level of a noise at the moment of detection. The noise level is a disturbance variable. The noise level is computed to determine the probability of detection in the ultrasonic sensor system and is available. The background-noise level may also be referred to as noise level. The noise level may be indicated in decibels, for example. The higher the noise level is, the less likely it is that a weak echo or a small object will be detected, because the echo bounced back from the object may disappear in the background noise. An echo that is significantly louder than the noise level results in a high probability of detection. Echoes having intensities in the range of the noise level may be classified as false positive objects.

A detection rate of the false positive objects is dependent upon the road condition. Different expected values may be stored for various road conditions. The expected values may be defined during vehicle tests, for example.

A dry condition may be detected as the current road condition when the current value of the detection rate is less than a dampness value. A moist condition may be detected as the current road condition when the current value is greater than the dampness value. A wet condition may be detected as the current road condition when the current value is greater than a wetness value. A hydroplaning condition may be detected as the current road condition when the current value is greater than a hydroplaning value. A warning message about hydroplaning risk may be provided at or above a velocity limit value, particularly upon detection of a wet condition. The dampness value, wetness value and hydroplaning value may be designations of expected values. The dampness value may be higher than a dryness value that characterizes a dry road condition. The wetness value may be higher than the dampness value. The hydroplaning value may be higher than the wetness value. Expected values of varying levels make it possible to detect different road conditions.

The method may include an adjustment step, in which a maximum-velocity value representing a maximally permissible velocity for the vehicle and/or a distance value representing a minimally permissible distance to a preceding vehicle are/is adjusted using the currently detected road condition. The approach presented here may intervene directly in a driver assistance system of the vehicle. The maximum velocity limit value and/or the distance value may also be adjusted as a function of an expected road condition in the area of the vehicle and/or in an area in front of the vehicle. The expected road condition may be indicated in road condition information communicated from a higher-level information network.

A water level in the area of the vehicle may be detected as a road condition. Different expected values may be assigned to different water levels. The detection rate changes depending on how much water is standing on the road. The more water is standing on the road, the higher the detection rate of false positive objects may be. At or above a certain water level and at or above a velocity dependent thereon, the tires of the vehicle lose contact with the road and float up. Hydroplaning occurs. The approach presented here makes it possible to warn of a hydroplaning occurrence before the critical velocity for the known water level or water level curve is reached.

The detection rate may be analyzed within a narrow-band frequency range. The detection rate may be analyzed in an ultrasonic spectrum, in particular. In a narrow frequency band, particularly in the case of approximately one single frequency, less interference results than in a wide frequency band. In the narrow-band frequency range of the echolocation of ultrasonic systems of about 48 to 50 kHz, the influence of the surface property is minimal when the roadway is dry. That is why these systems are especially well suited for detecting the road condition.

In addition, the detection rate may be analyzed using a velocity value representing a current velocity of the vehicle and/or wind information representing a current wind vector. Portions of the false positively detected objects are due to the airflow produced by the subject vehicle. These portions may be subtracted from the detected objects. The airflow produced by the subject vehicle is essentially dependent on the velocity thereof. The airflow produced by the subject vehicle is also dependent on the wind. In particular, a portion of the wind in the driving direction of the vehicle thereby influences the airflow produced by the subject vehicle. In other words, the airflow produced by the subject vehicle is greater in the presence of headwind and less in the presence of tailwind than the purely velocity-dependent wind of [airflow produced by] the subject vehicle. A wind vector thereby describes the direction and strength of the wind.

In the analysis step, detection rates captured by different sensors of the sensor system may be analyzed separately. The detection rate varies at different locations of the vehicle. For example, wind noises in the front section of the vehicle may be more pronounced than in the rear section.

The detection rates of sensors of the sensor system, which are installed mutually symmetrically on the vehicle, may be analyzed. Sensors are often installed on the vehicle in pairs. The sensor pairs may be analyzed together in order to recognize an imbalance in the detection rates.

To detect different road conditions, different detection rates of sensors of the sensor system installed at various positions on the vehicle may be used. A spatial distribution of the detection rates may be dependent on the road condition. In the case of a damp to wet road, the detection rate may be greater in the rear of the vehicle than in the front of the vehicle. In the case of a wet to flooded roadway, the detection rate may be greater at the front of the vehicle than at the rear of the vehicle.

The detection rate may also be analyzed using distance information representing a distance of the vehicle to at least one object, as well as a sound reflection property and/or a sound emission property of the object. Objects may be captured by a driving-environment sensing system of the vehicle, for example. The sensor system may be the driving-environment sensing system, for example. The driving-environment sensing system may provide distance information. The distance information may already be present in the sensor data as a measured quantity. For example, the sensor system may emit actively acoustic signals and analyze a propagation time of the signals as a measured quantity. Objects in the field surrounding the vehicle may cause noise or change an inherent noise of the vehicle. For example, a moving vehicle causes a driving noise that is able overlay the inherent noise. In the same way, a two-dimensional object, such as a tunnel wall or a guard rail next to the vehicle, may reflect the inherent noise of the vehicle.

An absolute velocity of the object and/or a velocity value representing a current velocity of the vehicle may be used to compute the sound emission property of the object. The intrinsic noise of the vehicle and/or the driving noise of another vehicle are/is velocity-dependent. The higher the velocity is, the louder is the intrinsic noise, respectively the driving noise.

The example method may feature a providing step in which road condition information representing the current road condition and position information representing a current position of the vehicle are provided for a higher-level information network. Alternatively or additionally, road condition information representing the current road condition may be provided by the higher-level information network for expected future positions of the vehicle. The providing process makes it possible to provide an overview of current road conditions in the information network. On the basis of the overview, predictive road condition information may be provided to other vehicles, enabling them to react predictively. The information network may be referred to as a cloud.

Also advantageous is a computer program product or computer program having program code, which may be stored on a machine-readable medium and used to perform, implement and/or control the steps of the method described above.

It should be appreciated that some of the possible features and advantages of the present invention are described herein as the method and apparatus with reference to various specific embodiments. One skilled in the art will recognize that the features may be suitably combined, adapted or exchanged to arrive at other specific embodiments of the present invention.

### BRIEF DESCRIPTION OF THE DRAWINGS

Specific embodiments of the present invention are described in the following with reference to the figures, the intention being for neither the figures nor the description to be interpreted as limiting the present invention.

FIG. 1 illustrates a vehicle having an apparatus for detecting a road condition in accordance with an exemplary embodiment.

FIG. 2 illustrates an information network for managing road condition information in accordance with an exemplary embodiment.

FIG. 3 illustrates a sensor signal included in sensor data and a noise level in accordance with an exemplary embodiment.

FIG. 4 shows a diagram of sensor data captured upon passage through a water basin, in accordance with an exemplary embodiment.

The figures are merely schematic and are not true-to-scale. In the figures, the same reference numerals denote like or functionally equivalent features.

### DETAILED DESCRIPTION OF EXAMPLE EMBODIMENTS

An example detection of the water level on the roadway via ultrasound is presented for a hydroplaning warning.

It is currently not possible to directly measure the wetness on the road, respectively to determine the water column on a roadway in millimeters. A wet roadway may be indirectly inferred from various operating states of a vehicle. This may be accomplished, for example, on the basis of the wiper activity or by ESP interventions. At the present time, a continuous “measuring” of the road condition with respect to moisture does not exist.

A vehicle may feature a driving-environment sensing system. For example, ultrasonic sensors may be placed near the wheel wells for obstacle detection. In the use of obstacle detection during relatively fast driving, a considerable problem is posed by the driving noises, which are superimposed on the signal emitted by the sensors and the echo therefrom and thus which, to some extent, greatly restrict the distance measuring. The more water the tires spray or splash up against the wheel wells, the louder is the driving noise and all the greater is the restriction. The noise level mainly attains the sensor directly through the air, but may also be indirectly received by the sensor via structure-borne noise. These noises are computed as a “noise quantity” in the sensor itself.

For the driver, or even for following vehicle drivers, it would be helpful in many situations to know the influence of the wet roadway or to be made aware of the effects in terms of the possible cornering speed or hydroplaning. This would enhance safety in road traffic. The information about the “water level” [mm] or “wet roadway” [yes/no] may also be stored and processed in a cloud.

The example method presented here may be used in all vehicles having ultrasonic sensors. Since only one already computed signal on the CAN bus is provided, and a warning is issued to the driver on the basis of this signal, a cost-effective, minimal implementation including software modifications to the ultrasonic control unit and the HMI is possible.

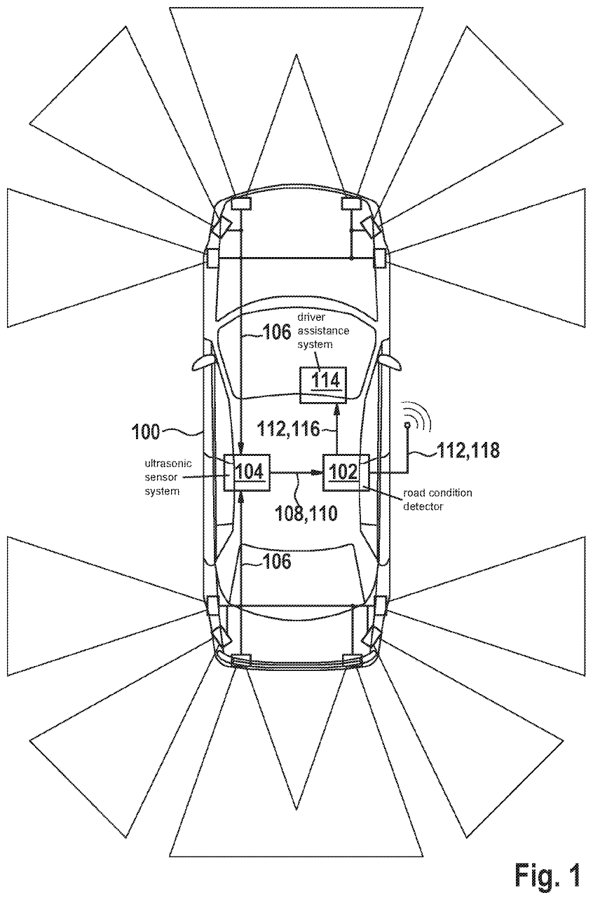

FIG. 1 illustrates a vehicle 100 having an example apparatus 102 for detecting a road condition in accordance with an exemplary embodiment. Here, vehicle 100 is a passenger car. Vehicle 100 has an ultrasonic sensor system 104 that has six sensors each at the front and rear ends. The sensors are oriented to different detection regions and configured symmetrically to the longitudinal axis of the vehicle. The sensors transmit ultrasonic signals to the detection regions thereof and record echoes returning therefrom. The sensors provide sensor signals 106, which reproduce the echoes, for sensor system 104. Sensor system 104 analyzes the information from sensor data 106 and provides sensor data 108.

Apparatus 102 reads in sensor data 108 and evaluates a detection rate of false positive objects, which is included in sensor data 108, to detect the road condition. The road condition is made available in the form of road condition information 112 for driver assistance systems 114 of vehicle 100, for example, a warning for a driver of vehicle 100 if the road grip diminishes because of the road condition.

An exemplary embodiment provides that apparatus 102 limit maximum values 116 for the velocity of vehicle 100 and/or a safety distance to a preceding vehicle, as a function of the detected road condition. For example, an intelligent cruise control of the vehicle may thereby adapt the velocity of vehicle 100 and/or the distance to the preceding vehicle to the road condition.

In an exemplary embodiment, apparatus 102 transmits road condition information 112 and position information 118 via a wireless connection to a higher-level information network. In this way, the information about the road condition in the area of vehicle 100 may also be passed on to other vehicles.

With the aid of ultrasonic sensors (USS), located near the wheel wheels or already installed for object detection, vehicle 100 detects how high the water level is on the roadway.

The ultrasonic system may perform water level detection parallel to object detection. Since, at low velocities, the object detection functions very effectively, the filter characteristics and other parameters of the sensors are optimized to object detection. In the approach presented here, a number and a distance of misidentified objects are analyzed as an indicator at a very low probability to make inferences about the water level.

The more water or slush is present on the roadway, the higher is the velocity-dependent noise level of the rain drops or slush particles sprayed onto the wheel well that is measured by the ultrasonic sensor. Generally, wetness may be captured by the rear sensors, since, here, the airflow produced by the subject vehicle overlays the noise level of the water to a lesser degree. The quantity of water that splashes against the wheel well, respectively the noise level may also be affected by the vehicle velocity, respectively wheel speed, the wind velocity and direction, other road users, objects on the side of the road, the installation position of the sensors, the vehicle geometry, any contamination of the sensors and the tire condition (cross section, width, profiling, etc.). All of these parameters also enter into the calculation of the water level.

If a velocity-dependent detection rate of false positive objects is greater by a first (velocity-dependent) factor than a velocity-dependent reference value for a dry roadway, then the road is (at least) damp. If the detection rate is greater by a second (velocity-dependent) factor than the velocity-dependent reference value for a dry roadway, then the road is (at least) wet, the second factor being greater than the first factor. Other still larger factors may be used to distinguish higher water levels from lower water levels, wet and damp roads.

Since, in the case of a dry road, a noise level at the sensor is mainly caused by the wind of the subject vehicle, head wind results in an increased level and tail wind in a reduced level. To ensure that a head wind does not lead to a dry road being mistaken for a damp road, and a tail wind does not lead to a damp road being mistaken for a dry road, vehicle 100 is able to measure the wind velocity with the aid of the fan wheel, for example, against which the wind of the subject vehicle flows, and compute the influence thereof therefrom. Alternatively, the current local wind velocity and direction may be retrieved over the Internet. Vehicle 100 adds the head wind to the current vehicle velocity and computes therefrom the wind-corrected velocity, in order to implement and improve the previously described water level calculation.

Not only do the noises of the wind of subject vehicle 100, but also those of the other road users greatly influence the noise level. By emitting ultrasonic pulses and measuring the reflections, vehicle 100 is able to detect other road users at average velocities and short distances.

All vehicles 100, which are equipped with sensors at the front and rear, may detect water on the road most reliably. If the vehicle has sensors only at the front or only at the rear, then it may detect other road users at high velocities, also with the aid of other sensor systems, such as radar, cameras or lidar, for example. If the vehicle has detected other road users, it uses alternative velocity-dependent factors to compute the water level.

If the detection rate is simultaneously increased at the front and rear, an EMC interference source may be the cause, since the signals thereof propagate at the speed of light and thus reach all sensors simultaneously. It may thereby be considered that the interference source injects into the sensors with varying intensity depending on the installation position.

The self-induced water noises are reflected by stationary objects, such as concrete walls, for example, and arrive at the sensors as amplified noises. If the vehicle detects stationary objects, it similarly uses other alternative velocity-dependent factors to compute the water level.

Since the sensors are seated at different distances from the wheels and may be covered by the vehicle body to varying degrees, velocity-dependent factors, specific to each sensor, are provided for computing the water level. The sensors are generally configured symmetrically to the longitudinal axis of the vehicle, making it possible for one velocity-dependent factor to be used on each of two mutually symmetrically configured sensors.

Preferably all available sensors are generally used for computing the water level. Thus, it may occur that the sensors assess different heights of the water level. Since the water level may be computed reliably or unreliably depending on the position of the sensors, the standard deviation of the signal is also individually specified for each position. Moreover, the sensor-specific standard deviation is corrected again if one of the above described influences acts on the sensor signal, respectively depending on which computation methodology may be applied. The computed water levels undergo a weighted merging using the standard deviations; if indicated, water levels having an especially high standard deviation being completely discarded. The standard deviation is likewise computed for the merged water level. The front sensors are able to detect very high water levels more reliably than those in the rear, it being difficult for the front sensors to detect damp and only moderately wet roads. For that reason, together with the front sensors' assessment of the water level, a high standard deviation is assumed for low water levels, and a low standard deviation is assumed for high water levels in the subsequent merging of the data. On the other hand, damp and wet roads may be detected very reliably with the aid of the rear sensors, while the rear sensors are not as efficient as the front sensors in detecting very short, but deep puddles. This realization is likewise considered in the merging of the measured values of all sensors by the standard deviation of the rear sensors being assumed to be small for measured low water levels and large for high water levels.

Pattern recognition may also be used, using the raw data of the ultrasonic sensor to determine an existing water level in accordance with a particular situation. On the basis of the drive past a vehicle, for example, an existing water level or road characteristic (dry, moist, wet, . . . ) may be inferred from the characteristic noise pattern, including the object detection pattern.

Primarily decisive at high water levels as to whether hydroplaning will occur already at lower or not until higher velocities are the tire cross section and the vertical tire force. Besides the tire cross section and the vertical tire force, the tire tread depth, as well as the profile pattern play an important role at low water levels.

Vehicle 100 learns at which velocities and water levels, signs of hydroplaning occur. Vehicle 100 detects this with the aid of sensors of the ESP, which, for example, computes the slip of the individual wheels and the vehicle stability on the basis of wheel speed information, the inertial sensor system, and the steering angle. If vehicle 100 becomes unstable or if the slip of individual wheels becomes unusually great, then this is a sign of imminent hydroplaning. The ESP is also able to make a determination as to whether the right or left side is affected by hydroplaning. Whenever vehicle 100 detects hydroplaning with the aid of the ESP sensor system, it stores the vehicle velocity, the vertical tire forces, and the water level, and also transmits this data to the cloud. Vehicle 100 is able to measure the water level, if present, using the ultrasonic system specific thereto or query the same from the cloud, or, from these empirical values, vehicle 100, respectively the cloud is able to better assess for the future how dangerous the currently measured water level is for respective vehicle 100 or how dangerous the predicted water level will be on the chosen route, and to what extent vehicle 100 needs to reduce the maximum velocity to be able to reliably avoid hydroplaning.

In the case of a damp roadway, the intelligent cruise control automatically adjusts a greater distance to the preceding vehicles, than in the case of a dry roadway. The emergency braking assist intervenes at an earlier stage than in the case of a dry road, to prevent a rear-end collision.

In the case of a wet road, the intelligent cruise control reduces the maximally selectable nominal velocity of the cruise control and automatically observes an even greater distance to the preceding vehicles than in the case of a damp roadway. If the driver exceeds a certain velocity, he/she is warned about hydroplaning. The emergency braking assist intervenes at an even earlier stage than in the case of a damp road, to prevent a rear-end collision.

In the case of a high water level on the road, the intelligent cruise control reduces the maximally selectable nominal velocity of the cruise control and automatically observes an even greater distance to the preceding vehicles than in the case of a wet road. The driver is warned already upon exceedance of velocities lower than in the case of a wet road. The emergency braking assist intervenes at an even earlier stage than in the case of a wet road, to prevent a rear-end collision.

In the case of a hydroplaning risk that is predicted for the long term, for example, in the case of increasing vehicle velocity at a constant water level, or in the case of a predicted puddle/rut, a reduction in the nominal velocity of the intelligent cruise control and in the speed limitation is implemented via the cloud. In addition, a reduction of the engine torque and/or a brake intervention (for example, during downhill rolling) may be implemented. The driver may be warned by a visual alert or a warning bleep, for example.

In the case of an acutely measured hydroplaning risk (sudden deep puddle/rut), the intelligent cruise control may be switched off, the engine torque reduced. Furthermore, targeted braking interventions may be performed to reduce the velocity and stabilize the vehicle. In the event of an acute hydroplaning risk, the front wheels, but not the rear wheels should preferably be used for braking to prevent the rear end from swerving. The driver may be warned by a visual alert or a warning bleep, for example.

Water on the road may be the cause of numerous defects and sporadic errors. If vehicle 100 detects an error in one of the components, it then stores not only the current ambient temperature, vehicle velocity and engine speed, but also whether the error occurred in the case of a dry, moist, wet or flooded road. Moreover, in the case of an especially rapid passage through very deep water, this event may be stored as such and this information made available to the service garage.

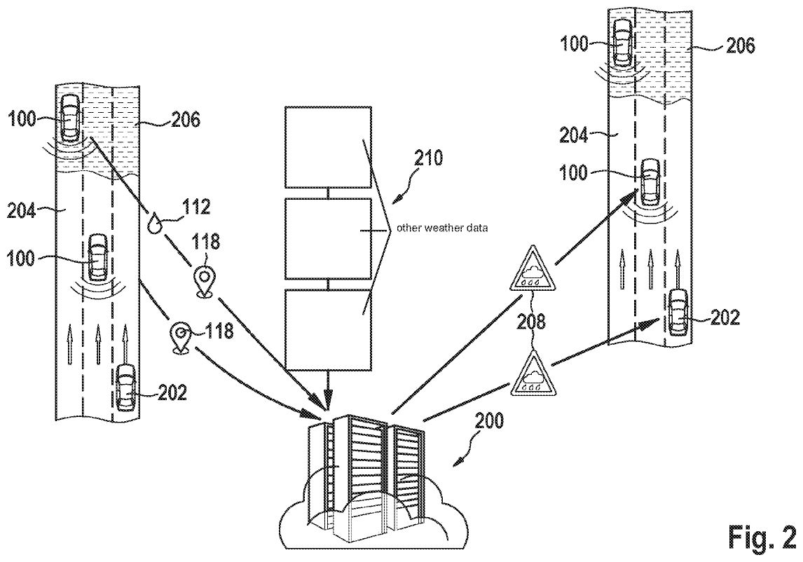

FIG. 2 illustrates an information network 200 for managing road condition information 112 in accordance with an exemplary embodiment. Information network 200 networks vehicles 100, as in FIG. 1, which feature an apparatus for detecting a road condition, with vehicles 202, which do not have such an apparatus.

In a situational example illustrated here, two vehicles 100 equipped with an apparatus and one vehicle 202, which is not equipped with an apparatus, drive on a road 204. Vehicles 100, 202 drive at relatively large distances behind one another. In particular, they drive outside of the range of vision. A route section 206 of road 204 features a modified road condition. Here 206, road 204 is wet in the route section, or even water is standing on the roadway. Preceding vehicle 100 equipped with the apparatus has reached route section 206. The apparatus detects the road condition at least as wet, since the detection frequency of false positive objects in route section 206 is appreciably higher than in a dry route section. In particular, the detection frequency of false positive objects is higher than for a wet value. The apparatus transmits road condition information 112 and position information 118 to information network 200. Road condition information 112 at least includes information about the road condition detected as wet.

Second vehicle 100 equipped with the apparatus has not yet reached route section 206. Second vehicle 100 rides on dry road 204. Second vehicle 100 also transmits information to information network 200. Since the road condition is detected as being normal; only position information 118 is communicated here.

A position of third vehicle 202 is known here at least approximately from other sources. The relative positions of vehicles 100, 202 are correlated in information network 200. It is thereby detected that second and third vehicles 100, 202 are located just in front of wet route section 206 and will soon reach the same. For that reason, a warning 208 about wetness is sent to second and third vehicles 100, 202. Thus, driver assistance systems and/or the drivers of second and third vehicles 100, 202 may react accordingly, for example, by adapting the velocity and/or the safety distance to the wet road conditions to be expected.

Via a mobile radio link, vehicle 100 signals the computed water level and the standard deviation, together with the GPS position and, if indicated, the current lane or travel direction, to the cloud which merges these data with the data from other vehicles 100, and with other weather data 210, and checks the plausibility thereof. Even vehicles 202, which are not able to compute the water level themselves, are able to retrieve the predicted maximum water levels or still certain maximum velocities, from the cloud for the next probable route sections.

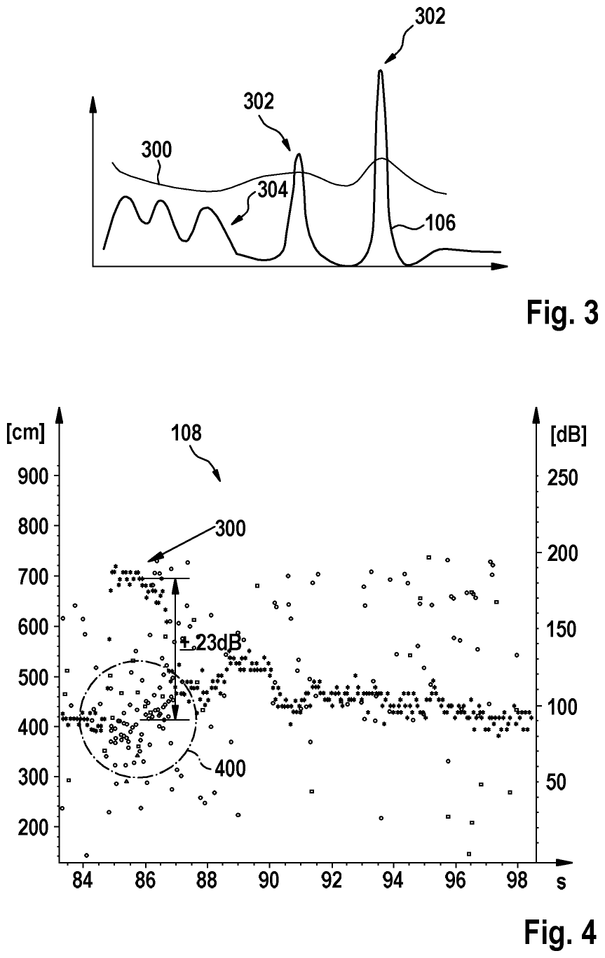

FIG. 3 illustrates a sensor signal 106 and noise level 300 included in sensor data, in accordance with an exemplary embodiment. The sensor data thereby essentially correspond to the sensor data in FIG. 1. Sensor signal 106 and noise level 300 are shown in a diagram where time is marked on the abscissa thereof and an intensity on the ordinate thereof. An echo 302 of a signal transmitted by the sensor is produced by sensor signal 106 and is received at a sensor. Here, the time represents a propagation time of the signal and of echoes 302. A curve of sensor signal 106 begins at a moment of transmission of the signal. The signal is not shown. Here, the signal is an ultrasonic signal. The ultrasonic signal propagates from the sensor at sound velocity. Upon striking an object, the ultrasonic signal is bounced back, respectively reflected and propagates again at sound velocity. First illustrated echo 302 represents the portion of the transmitted signal that is recorded at a first moment of reception. Second illustrated echo 302 represents the portion of the transmitted signal that is recorded at a second moment of reception. The shorter a period of time is between the moment of transmission and the moments of reception of echoes 302, the smaller is a distance between the transmitter and the object.

If no echo 302 is received, the sensor produces a background noise 304 in sensor signal 106. Second echo 302 here has an appreciably higher intensity than background noise 304. First echo 302 has an only slightly greater intensity than background noise 304. To be able to distinguish echoes 302 from background noise 304, noise level 300 is ascertained from background noise 304. Noise level 300 is based on a floating mean value of sensor signal 106. In addition, in comparison to the mean value, noise level 300 is shifted slightly toward greater intensities. Echoes 302 are short and feature a considerable edge steepness. The intensity of echoes 302 exceeds noise level 300. The more an echo 302 exceeds noise level 300, all the greater is the probability of an echo 302 reflected off of the object actually being detected. Conversely, the probability of detection is all the less, the weaker echo 302 is in comparison to noise level 300. Echoes 302, which have an only somewhat higher intensity than noise level 300, but only slightly exceed the same, are marked as false positively detected echoes 302, but are not suppressed.

Each sensor measures an individual background noise. This minimal noise may always be learned when acoustic signals are to be excluded as the cause or are unlikely. Before further computations are made available, the learned individual background noise of each sensor is always deducted from the measured raw value.

FIG. 4 shows a diagram of sensor data 108 captured upon passage through a water basin in accordance with an exemplary embodiment. Sensor data 108 are shown in a diagram where a time progression is marked in second(s) on the abscissa thereof. Two mutually independent variables are marked on the ordinate. One variable is a distance value in centimeters (cm) for received echoes 302. The other variable is a value of noise level 300 in decibels (dB). Sensor data 108 thereby reproduce a plurality of successive measurements. For each measurement, at least one value is shown for noise level 300. When an echo 302 reflected off of an object is received, a propagation time of the echo is shown as a distance value. Also known is a probability of detection of the echo. Noise level 300 and echoes 302 are characterized by different symbols.

A vehicle capturing these sensor data 108 essentially corresponds to the illustration in FIGS. 1 and 2 and is driven through the water basin at a velocity of between 30 km/h and 100 km/h. Because of hydroplaning, the vehicle thereby momentarily loses contact with the ground. Upon passage through the water basin, noise level 300 increases suddenly by up to 23 dB. After the water basin, noise level 300 drops again to approximately the same level as before the water basin.

While the vehicle is being driven through the water basin, the sensor momentarily captures many echoes 302 from false positive objects 400. A detection rate of the false positive objects increases suddenly. Before the vehicle reaches the water basin, only a few false positive objects 400 are captured. The detection rate there is low. After the water basin, the detection rate is again similarly low.

In the approach presented here, the detection rate is evaluated in order to make inferences about the road condition. To this end, a value of the detection rate is compared to at least one expected value for the road condition. The road condition is detected using a result of the comparison.

Different expected values have been defined for various road conditions. The expected values are also dependent on a vehicle type and an installation position of the sensor in the vehicle.

The sensors have a natural measurement noise, which leads to false detection of objects 400 (false positive or FP objects 400). The sensors may be configured in such a way that theoretically 20% of the FP objects 400 are attributable to the measurement noise. This configuration makes it possible to ensure that even very weak echoes are still able to be detected by the sensor, relayed to the control unit and evaluated by the same.

Wind noises and wetness may increase the noise at the sensors and thereby also allow the number of FP objects 400 to increase by over 20%. Water on the road may, therefore, also be detected by evaluating the number of FP objects 400.

Noise level 300 increases appreciably upon passage through the hydroplaning basin, which is why FP objects 400 are also increasingly detected at that time. In the further course, noise level 300 and the number of FP objects 400 decrease again. Rain drops, which hit the sensor surface, may likewise result in FP objects 400, the number thereof being independent of noise level 300. For that reason, noise level 300 may then be inferred from the number of FP objects 400, in fact, when it is possible to rule out that the sensor signals are influenced by rain drops. This is the case at high vehicle velocities, especially for rear-mounted and side-mounted sensors.

Finally, it is pointed out that terms, such as “having,” “including,” etc. do not exclude any other elements or steps, and terms, such as “one” or “a,” do not exclude a plurality.

1-15. (canceled)

16. A method for detecting a road condition in an area of a vehicle using sensor data from an acoustic sensor system of the vehicle, the method comprising the following steps:
receiving sensor data from the acoustic sensor system of the vehicle; and
analyzing a detection rate of false positive objects reproduced in the sensor data to detect a current road condition, a current value of the detection rate being analyzed using at least one expected value assigned to a road condition.

17. The method as recited in claim 16, wherein, in the analyzing step: (i) a dry condition is detected as the current road condition when the current value of the detection rate is less than a dampness value, and/or (ii) a dampness condition is detected as the current road condition when the current value is greater than the dampness value, and/or (iii) a wet condition is detected as the current road condition when the current value is greater than a wetness value, and/or (iv) a hydroplaning condition is detected as the current road condition when the current value is greater than a hydroplaning value, a warning message about a hydroplaning risk being provided at or above a velocity limit value.

18. The method as recited in claim 17, wherein the warming message is provided upon detection of the wet condition.

19. The method as recited in claim 16, further comprising the following step:
adjusting, using the currently detected road condition, a maximum-velocity value representing a maximally permissible velocity for the vehicle and/or a distance value representing a minimally permissible distance to a preceding vehicle.

20. The method as recited in claim 16, wherein, in the analyzing step, a water level in the area of the vehicle is detected as a road condition, different expected values being assigned to different water levels.

21. The method as recited in claim 16, wherein, in the analyzing step, the detection rate is analyzed within a narrow-band frequency range.

22. The method as recited in claim 21, wherein the detection rate is analyzed in an ultrasonic spectrum.

23. The method as recited in claim 16, wherein, in the analyzing step, the detection rate is analyzed using a velocity value representing a current velocity of the vehicle and/or wind information representing a current wind vector.

24. The method as recited in claim 16, wherein, in the analyzing step, detection rates captured by different sensors of the sensor system are analyzed separately.

25. The method as recited in claim 24, wherein, in the analyzing step, the detection rates of sensors of the sensor system, which are installed mutually symmetrically on the vehicle, are analyzed.

26. The method as recited in claim 24, wherein, in the analyzing step, different detection rates of sensors of the sensor system installed at various positions on the vehicle are used to detect different road conditions.

27. The method as recited in claim 16, wherein, in the analyzing step, the detection rate is analyzed using distance information representing a distance of the vehicle to at least one object, and a sound reflection property and/or a sound emission property of the object.

28. The method as recited in claim 27, wherein, in the analyzing step, an absolute velocity of the object and/or a velocity value representing a current velocity of the vehicle are used to determine the sound emission property of the object.

29. The method as recited in claim 16, further comprising the following step:
providing: (i) first road condition information and position information, by the vehicle to a high-level information network, the first road condition information representing the current road condition, the position information representing a current position of the vehicle, and/or (ii) road condition information, by the higher-level information network to the vehicle, the road condition information representing current road conditions for expected future positions of the vehicle.

30. An apparatus configured to detect a road condition in an area of a vehicle using sensor data from an acoustic sensor system of the vehicle, the apparatus configured to:
receive sensor data from the acoustic sensor system of the vehicle; and
analyze a detection rate of false positive objects reproduced in the sensor data to detect a current road condition, a current value of the detection rate being analyzed using at least one expected value assigned to a road condition.

31. A non-transitory machine-readable storage medium on which is stored a computer program for detecting a road condition in the area of a vehicle using sensor data from an acoustic sensor system of the vehicle, the computer program, when executed by a computer, causing the computer to perform the following steps:
receiving sensor data from the acoustic sensor system of the vehicle; and
analyzing a detection rate of false positive objects reproduced in the sensor data to detect a current road condition, a current value of the detection rate being analyzed using at least one expected value assigned to a road condition.
